(19) United States
(12) Patent Application Publication
(10) Pub. No.: US 2007/0056676 A1
(43) Pub. Date: Mar. 15, 2007

(54) Method and device for attaching sheeting to surfaces of structures

(76) Inventor: Paul Vogt, Schonenbuch (CH)

Correspondence Address: LADAS & PARRY, 26 WEST 61ST STREET, NEW YORK, NY, 10023, US

(21) Appl. No.: 10/562,847

(22) PCT Filed: Jun. 30, 2004
(86) PCT No.: PCT/CH04/00414

§ 371 Date: Jun. 22, 2006

(30) Foreign Application Priority Data
Jul. 1, 2003 (EP) 03014446.3

(51) Int. Cl. B32B 37/12; E04F 13/00; B44C 7/00

(52) U.S. Cl. 156/71; 156/574; 156/575; 156/577

(57) ABSTRACT

In order to place sheetings (15) on tunnel walls (3), a device (1) is used that, together with the sheeting supply (5), carries along a melting device (7, 8) for hot-melt-type adhesive during a placing movement. The device comprises a displacing device (4), which has an arm (12), can be displaced in a horizontally parallel manner on the supporting structure, and which can pivot about a pivot axis (11). This enables sheetings to be easily placed on tunnel walls.

### INDICATION OF RELATED APPLICATIONS

This Application claims the priority of the European Patent Application 03 014 446.3, which was filed on Jul. 1, 2003 and its entire disclosure is incorporated herewith by reference.

### BACKGROUND

The invention concerns a method for attaching foil sheetings to surfaces of structures, in particular to tunnel walls, in which at least one roll of foil is moved by an installation movement along the surface to be covered and thus the sheeting is pulled off the roll and is applied to the surface, whereby the sheeting is attached to the surface by a hot-melt-type adhesive prepared by a melting device. The invention also concerns a method for attaching sheeting according to the preamble of claim 6. In addition, the invention concerns corresponding devices for attaching sheeting to surfaces of structures, in particular to tunnel walls, according to the preamble of claims 13 or 14, respectively. In addition, the invention concerns the use of foamed hot-melt-type adhesive for attaching sheeting, in particular to pneumatically-applied concrete surfaces of tunnel arches.

### PRIOR ART

A method or a device for the installation of sheeting is known from WO 01/02700. This document shows the installation of foil sheetings by means of an installation vehicle, which travels along a guide track adapted to the surface of the structure. The sealing sheeting which is pulled off a roll is attached by means of a hot-melt adhesive. The melting device for the adhesive is disposed in a stationary manner on a gantry crane, which bears the guide track. A heatable working storage tank is provided for the adhesive on the installation vehicle, and this tank can be filled with molten adhesive from the stationary melting device when the installation vehicle is at an end position. This known arrangement is an enhancement of the arrangement known from CH-A-652,448, in which the installation device is connected to the stationary melting device by means of a flexible tubing.

### PRESENTATION OF THE INVENTION

The object of the invention is to create an improved installation method.

This is achieved for the installation method of the type named above by guiding the melting device along with the roll of foil in the installation movement.

Unlike the prior art, the entire melting device with the roll of foil is moved along the surface of the structure and is not stationary during the installation of a sheeting. In this way, very short connection lines from the melting device up to the site of application of the hot-melt-type adhesive on the sheeting are possible. Long lines containing hot-melt-type adhesive that are sensitive to disruptions are thus omitted and special dispensing valves are also dispensed with. The hot-melt-type adhesive is prepared directly when the sheeting is installed by the melting device that is moved along with it.

Even more preferred, a melting device is utilized, which produces a foamed hot-melt-type adhesive by introducing gas. In this way, it is also more preferable that the gas supply required for this purpose is moved along together with the melting device in the installation movement. The foamed hot-melt-type adhesive, when compared with the unfoamed hot-melt-type adhesive which was used previously, shows the advantage of a smaller consumption of adhesive per square meter of foil, the dripping of molten adhesive in overhead application is very small or even completely absent, and increased adhesive force is provided. It has been shown that foamed hot-melt-type adhesive makes possible the direct adherence of sheeting to pneumatically-applied concrete.

It is preferred if the melting device is guided along on a platform that remains essentially horizontal during the installation movement. This permits the use of a melting device that is commonly used for stationary operation also for this moving installation. Preferably, the platform is configured as a work staging, which makes possible the co-transport of an operator or control person during the installation and the application of the hot-melt-type adhesive.

The procedure according to the invention can be used with any installation device. For example, this could be an installation vehicle according to WO 01/02700, which then guides the melting device, however, according to the invention. Preferred, however, is a pivotable, length-adjustable displacing device for conducting the installation movement, in particular a pivotable, length-adjustable arm, especially a telescopic arm, instead of a vehicle traveling on a pregiven guideway. The preferred embodiment permits a simple adaptation to the most varied surfaces of structures, particularly different tunnel profile diameters.

Another object of the invention is to create an improved device for attaching sheeting.

This is achieved with the device named above with the characterizing features of claim 13. Due to the fact that the melting device is guided along with the uptake for the roll of foil in the installation movement, the advantages explained previously, which were based on the method, will result.

Another object of the invention is to create an improved possibility for conducting the installation movement.

This object is solved by a method or a device with the characterizing features of claim 6 or 14, respectively.

Due to the fact that the uptake for the roll of foil is disposed on a horizontally adjustable and pivotable displacing device for conducting the installation movement, there results a device that can be simply adapted to different running surfaces of structures, in particular, different tunnel profiles.

A length adjustment is preferably provided, in particular a length-adjustable arm, especially a telescopic arm. It is also preferred if the lengthwise axis of the uptake for the roll of foil can be pivoted each time in the horizontal plane running through it. In addition, it is preferred if the lengthwise axis of the foil uptake can be inclined out from the horizontal plane. More preferably, one or the other or both of the named movements of the lengthwise axis of the roll of foil uptake is (are) conducted at the end of the displacing device opposite the roll of foil uptake, in particular, of the telescopic arm. In particular, the movements are made by mounting the displacing device, especially the arm or telescopic arm appropriately on the supporting structure, so that the named movements can be carried out independently of one another and independently from the installation movement. Preferably, a second displacing device, in particular, another telescopic arm is provided, which displacing device can be moved independently from the first displacing device. The second displacing device, e.g., can be displaced linearly and can be pivoted. It preferably bears the welding device for the foils.

The supporting structure for the displacing device is preferably a gantry crane, which can be moved along the structure, and, in particular, can be moved on rails inside a tunnel. The displacing device preferably can be introduced on the gantry crane and the gantry crane itself can be brought into a transport position.

The invention also concerns the improvement of the adhesive attachment of sheeting to tunnel walls, in particular of pneumatically-applied concrete and consists of the fact that a foamed hot-melt-type adhesive is used for this purpose.

### BRIEF DESCRIPTION OF THE DRAWINGS

Embodiment examples of the different aspects of the invention are explained in more detail below on the basis of the drawings. Here:

FIG. 1 shows schematically an installment device for explaining the invention;

FIG. 2 shows a view of a detail of FIG. 1;

FIG. 3 shows schematically another installment device;

FIG. 4 shows a view of a detail of the front end of the displacing device;

FIG. 5 shows a top view onto the installment device of FIG. 3;

FIG. 6 shows a sectional view in order to explain the mounting of the displacing device on the supporting structure;

FIG. 7 shows another sectional view in order to explain the mounting of the displacing device on the supporting structure;

FIG. 8 shows a top view onto the front end of a displacing device;

FIG. 9 shows a sectional view of FIG. 8;

FIG. 10 shows a section along line A-A of FIG. 9;

FIG. 11 shows a section along line B-B of FIG. 9;

FIG. 12 shows another embodiment of the device; and

FIG. 13 shows a schematic representation relative to the pivotability of the lengthwise axis of the roll of foil in the horizontal plane.

### EMBODIMENTS OF THE INVENTION

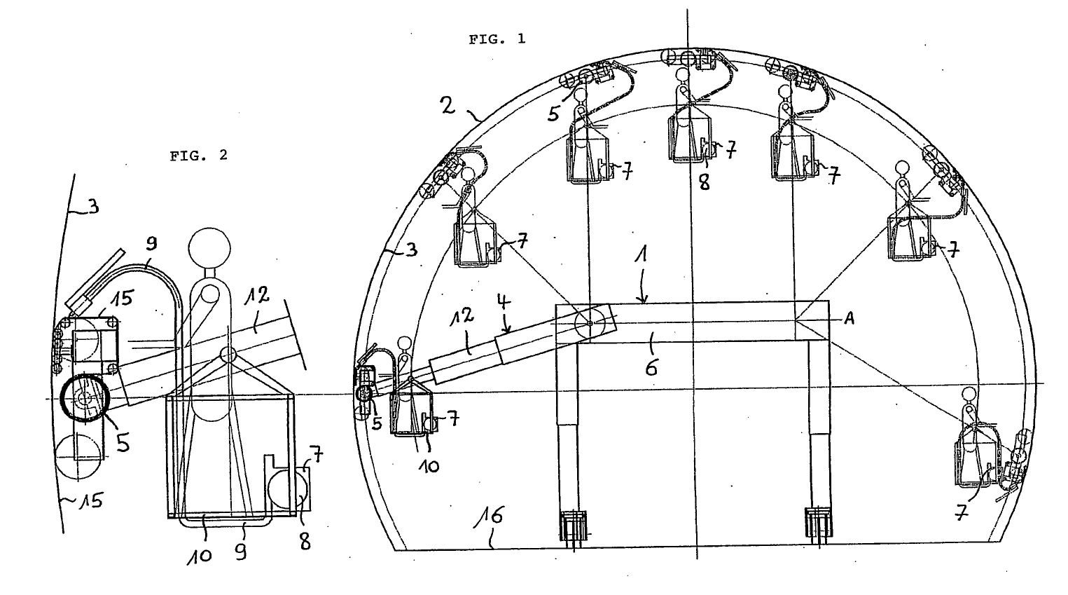

FIG. 1 shows schematically an installment device 1 disposed in a tunnel arch 2. The tunnel arch 2 is taken as an example of any structural surface. A seal in the form of sheeting will be installed on the inside 3 of the arch, which will be introduced in the known way so that the sheetings are overlapped one piece after another along the extent of the tunnel length on the inside wall of the tunnel, by adhering one piece of foil sheeting after another to the wall, from one intersection of wall 3 with the bottom 16 of the tunnel to another intersection of wall 3 with the bottom 16. Foil is meant here to be any type of foil-type sealing material, e.g., a plastic sealing sheet, PSS, or any other foil-type material, which finds use as sheeting in tunnel construction or in other surfaces of structures. It may involve one-layer or multi-layer foil sheetings or even woven sheets or nonwoven sheets which will also be included here by the term foil sheeting or such sheetings in combination with plastic foils. The sheetings are installed in tunnel construction usually with their edge regions overlapping and are welded in the overlapping region. The foil sheetings are produced as rolls of material, whereby one roll may have, e.g., a weight of 150-200 kg. The foil sheetings could also be present as folded packages, which, however makes no difference for the present invention; both types of foil manufacture or of foil supply will be included here. In the first aspect of the present invention, the foil sheeting is attached to the inside tunnel wall 3 by means of a hot-melt-type adhesive. Here, all types of adhesives are intended, which are liquefied by heating and become capable of being processed and solidify upon cooling and join the parts that are to be glued together in this way. Other names for such adhesives are, e.g., hot-setting adhesives or hot melts.

FIG. 1 now shows schematically a device 1 according to the first and the second aspects of the invention with a displacing device 4, which is disposed on a supporting structure 6 of the device so that it can pivot around an axis 11. On its free end, the displacing device 4, among other things, bears a roll of foil 5. This roll 5 is moved by the displacing device along the wall of the structure or the tunnel wall in a continuous installation movement, so that the sheeting rolled out from the roll covers the wall. This is shown in FIG. 1 by different positions of the roll of foil 5 along the tunnel wall. The sheeting is glued to wall 3 by applying onto the sheeting several beads of adhesive continuously or with breaks extending along its length, spacing the beads at intervals from one another, just before pressing the sheeting to the wall. These beads of heated, liquid hot-melt-type adhesive are cooled during and after the foil is pressed to the wall and create the adhesive joint between wall 3 and the foil sheeting.

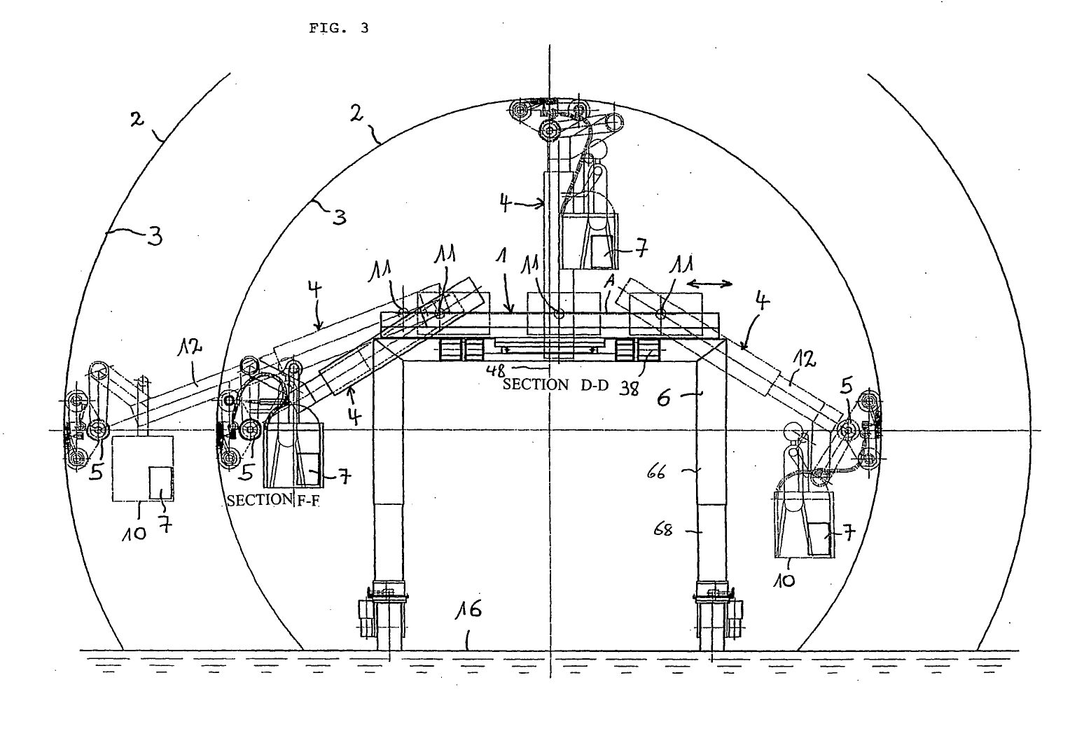

According to a first aspect of the invention, the melting device which produces the liquid hot-melt-type adhesive is now guided along in the installation movement together with the roll or package of foil or other type of sheeting supply. For this purpose, FIG. 1 and FIG. 2 show that the melting device 7, which is a known, common commercial melting device for hot-melt-type adhesives, is disposed on the displacing device 4 that also bears the roll of foil 5, from which the foil sheeting 15 is drawn off. The melting device can thus be disposed in any manner on the displacing device, so that it moves together with the supply of foil (roll or package of foil). In the example shown in FIG. 1 and FIG. 2, the melting device 7 is disposed on a platform 10, which is suspended on the displacing device in such a way that the platform remains essentially horizontal in the movement along the surfaces of structure 3 or tunnel walls 3 to be covered. This can be seen from the different positions of platform 10 in FIG. 1. From melting device 7, at least one line 9 leads to application heads 17, which deposit the adhesive beads onto foil sheeting 15 rolled out from the roll 5. One line 9 can be provided for this, which leads to a a crosspiece containing the adhesive, and this crosspiece has several outlet openings on it, spaced at intervals. It is preferred, of course, if several separate application heads 17 are provided, for each of which there is a separate line 9 from melting device 7. The transport in lines 9 to the application heads is usually conducted by means of a pump provided in the melting device. If the melting device itself does not contain a pump, then a separate pump arrangement is to be provided for this purpose. The melting device 7, which is guided along with the displacing device, is preferably a melting device for the production of foamed hot-melt-type adhesive. Such a preferably used melting device, e.g., of the type “Foam-Melt 200®” is marketed, e.g., by the company Nordson Deutschland GmbH, Erkrath, Germany, or by other branches of the Nordson company. This melting device produces a foamy hot-melt-type adhesive from the known solid hot-melt-type adhesive with the introduction of a gas, e.g, industrial carbon dioxide or nitrogen. This gas can be discharged onto the foil in the named manner via lines 9 and application heads 17. More preferably, for this purpose, the gas supply will also be guided along together with the displacing device, which is shown in FIGS. 1 and 2 by a gas tank 8. By guiding a melting device along together with the foil supply in the installation movement, as can be seen in the figures, it results that a particularly simple construction and a short guide line are provided for the hot-melt-type adhesive when it is hot. In order to operate the melting device when it is guided along together with the displacing device, only the introduction of electrical power is required for the melting device. The required quantity of solid hot-melt-type adhesive, which is then melted in the melting device, can be taken up in it and guided along. When a platform is provided, a supply of solid hot-melt-type adhesive, which is sufficient for several complete installation movements, can be carried along on it. In any case, the melting device should be dimensioned in such a way that it can contain sufficient hot-melt-type adhesive at least for one complete installation movement, as shown in FIG. 1. In the case of the preferred use of foamed hot-melt-type adhesive, the installation is the same as described above for standard hot-melt-type adhesives. It has been shown that the foamed hot-melt-type adhesive in the present Application has several advantages. Thus, e.g, if overhead operation is undertaken, as takes place normally in the installation movement on a tunnel wall, practically no dripping of hot-melt-type adhesive occurs. Further, due to the foaming, less hot-melt-type adhesive material is necessary, and there results an increased adhesive force. The use of foamed hot-melt-type adhesives makes it possible, in fact, to glue foil sheeting directly onto tunnel walls 3 made of pneumatically-applied concrete. This could not always be reliably carried out previously with conventional, unfoamed hot-melt-type adhesives. For example, type Ecomelt A3 EX159 of the company Collano AG, Switzerland, is applied as a preferred hot-melt-type adhesive for application onto pneumatically-applied concrete in tunnel construction. The described aspect of the invention, according to which the melting device is conveyed along with the installation movement, can be used basically for any means of conducting the installation movement. Thus, it is possible throughout, in the case of an installation vehicle, which is moved along a guide track, to also carry along the melting device.

According to another aspect of the invention, the displacing device 4, which carries out the installation movement, is designed in such a way that it comprises a pivotable element, which is, in particular, a pivotable arm 12 and especially a pivotable telescopic arm 12, which can be pivoted around an axis 11 on the supporting structure 6 in order to carry out the installation movement. As can be seen from FIG. 1, the axis 11 can be moved in parallel from one side of the supporting structure to the other side of the supporting structure (along line A), so that an expanded region results for the installation movement. In the example, the displacement is made horizontally, which is preferred.

FIG. 3 shows schematically an embodiment similar to that of FIGS. 1 and 2, wherein the same reference numbers denote the same elements, and wherein different positions of the lengthwise adjustable arm 12 are shown in FIG. 3, namely an end position with the minimum length of the extendable telescopic arm 12 and a position in which the telescopic arm is fully extended. Tunnel profiles of different size can be processed accordingly with the installation device.

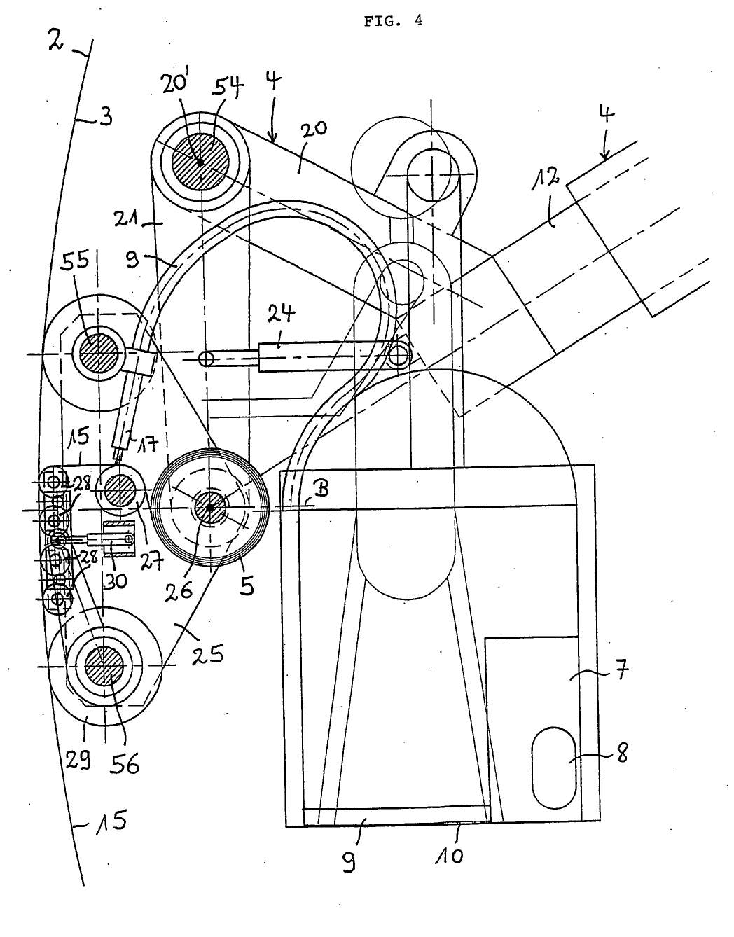

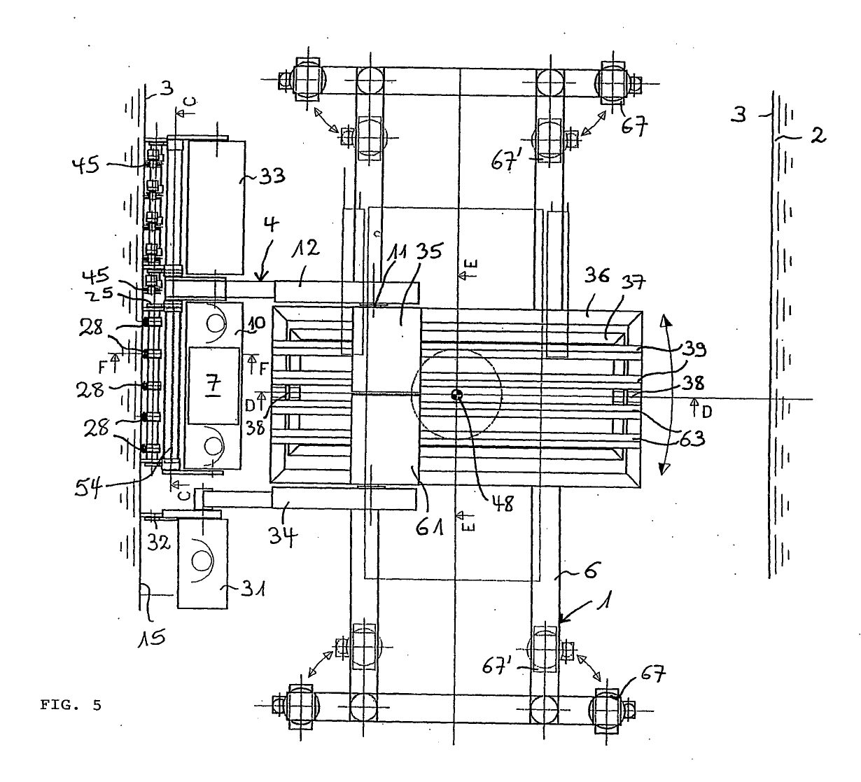

In a sectional view along line F-F of FIG. 3 or 5, respectively, FIG. 4 shows a preferred embodiment of the end of the displacing device 4 turned toward tunnel wall 3, which device in this case again has a length-adjustable arm 12, and, in particular, a telescopic arm. The length adjustment can be made pneumatically, hydraulically or also by a motor. An extension arm 20, to the free end of which is attached a lever 21 that can pivot around an axis 20′ is disposed in fixed manner at the end of telescopic arm 12. Lever 21 in turn bears at its other end the uptake for the roll of foil 5, which uptake or roll has a lengthwise axis 26. Roll 5 can be mounted in rotatable manner in this foil roll uptake with lengthwise axis 26, so that the foil can be pulled off of roll 5 as a sheeting 15. The foil sheeting reaches at least one compression roll via a deviating unit 27, and this roll compresses the foil onto the surface of the structure 3. In the example of FIG. 4, several sets of four compression rolls 28 each are provided, but only one such set is shown in the representation of FIG. 4. These sets of compression rolls each act in the region of the foil sheeting on which the adhesive is applied. Bar-shaped supports 55 and 56 disposed coaxially with the axis of the roll, together with a rear shield 25 and a front shield 25′, which is not visible in FIG. 4, form a supporting element, which forms the uptake with the lengthwise axis 26 for roll 5. The supporting element can thus be designed in such a way that a full roll 5 can be suspended in a simple way in the supporting element and can be attached thereon so that it can rotate. The supporting element attached to lever 21 is thus pressed against the tunnel wall by a hydraulic or pneumatic pressing element 24, which is supported at arm 12 and at lever 21. Plattform 10 in this example is also disposed in a pivotable manner around axis 60 on extension arm 20, so that it always remains essentially horizontal. Plattform 10 can be designed more preferably as an accessible work staging, so that a monitoring person can monitor the application of the adhesive onto the foil sheeting and its introduction onto wall 3. The hot-melt-type adhesive is introduced onto foil sheeting 15 in this example, again via a melting device 7 which travels along with the displacing device, and its connection with flexible tubing 9 is not shown in FIG. 4. The aspect of the pivotable and length-adjustable displacing device that is shown is more preferably combined with the previously explained aspect of co-transport of the melting device. The aspect of the pivotable and length-adjustable displacing device, however, can also be combined with conventional, stationary melting devices or in any case, can in fact be used with attachment means other than adhesive for the foil sheeting, e.g., with Velcro fastening means.

Other preferred embodiments of the device or of the method, respectively, will be explained on the basis of FIGS. 3 and 5-7. As can be seen from FIG. 3, the displacing device 4 is disposed on the top of a gantry crane 6. This vehicle has wheels, by means of which it can be moved along the tunnel. In this way, the foil sheetings can be introduced next to one another, in a displaced manner relative to one another, by the installation movement on the tunnel walls. A vehicle 35 of the displacing device, which bears the pivot axis 11, can thus move, preferably horizontally, on the upper side of the supporting structure 6 formed by the gantry crane, in order to be able to move around the pivot axis 11. In the top view of FIG. 5, it can be seen that the pivot axis 11 is moved by a vehicle 35, which can move on rails 39 on the supporting structure 6. In the top view of FIG. 5, the platform 10 disposed on arm 12 is again visible. In this example, the melting device 7 is disposed approximately in the middle of platform 10. In the configuration as a work staging, there is room for two persons, one on either side of the melting device 7, which most preferably also holds the gas supply and in any case, holds supplies of hot-melt-type adhesive. In the example shown, on arm 12, in addition to the uptake for the roll of foil, on the other side of the arm, a treatment device is disposed for treating the tunnel walls, which will be explained in more detail below. This operating device has wire brushes 45 and/or milling cutters as well as a work staging 33. In addition, it can be seen in this example that another vehicle 61, which preferably can be moved independently from the first vehicle, can be provided on the supporting structure and this second vehicle is moved on another track 63 and bears a displacing device, preferably an arm 30. This arm is also pivotable and adjustable in length and bears at least the welding device 32, which welds the foil sheeting 15 that is being directly installed onto the already previously installed foil in the known way. In addition, a work staging 31, which is also supported on arm 30, can be assigned to the welding device 32. The welding operation can be optimally fine-tuned to the installation by means of this second displacing device, which is preferably independent of the first displacing device.

More preferably, the position of the lengthwise axis 26 of the uptake device for the roll of foil can not only be moved along the surface of the structure or the tunnel wall 3 by the installation movement, but also is adjustable in its position relative to wall 3. This adjusting comprises a pivoting movement and/or an inclining movement of the lengthwise axis 26 of the uptake for the roll of foil. For this purpose, if one considers FIG. 4 and imagines a plane B which runs horizontally thereto and through which runs axis 26, then the lengthwise axis 26 of the uptake for the roll of foil lies in this plane and in fact parallel to the line of intersection of plane B with tunnel wall 3. Thus, corrections of the foil sheeting and a uniform overlapping of the preceding foil sheeting, even when the tunnel follows a curve, can be conducted during the installation movement; here, the lengthwise axis 26 can first be inclined in plane B so that, in the inclined position, the lengthwise axis does not run parallel to the line of intersection of plane B with wall 3. An additional preferred possibility for correction consists of the fact that the lengthwise axis 26 is inclined so that lengthwise axis 26 no longer lies in plane B, but rather runs obliquely to it, so that one end of the axis lies above plane B and the other end of the axis lies below it, and axis 26, viewed geometrically, still has in common only one point with plane B. These adjustment possibilities for axis 26 may be provided in the roll uptake itself, but in the example shown and more preferably, they are conducted at the other end of the displacing device 4 and are supported on supporting structure 6 or the gantry crane. FIG. 13 shows the corresponding mounting of the displacing device 4 with arm 12, which bears axis 26, in rough schematic representation viewed from the top. Vehicle 35 with pivot axis 11 for arm 12 is visible. The position of the arm is, e.g., also essentially horizontal and axis 26 lies in horizontal plane B. In the normal position of vehicle 35 relative to plane B, which is shown, axis 26 lies in plane B and runs parallel to the line of intersection of plane B with tunnel arch 2. Now, if vehicle 35 rotates around an axis 48, which is perpendicular to plane B, then the end of arm 4, which bears lengthwise axis 26, moves along circle line C and pivots axis 26 (with the roll of foil) in plane B in such a way that it is no longer parallel to the line of intersection of plane B with tunnel wall* 2.
sic; arch?—Trans. note

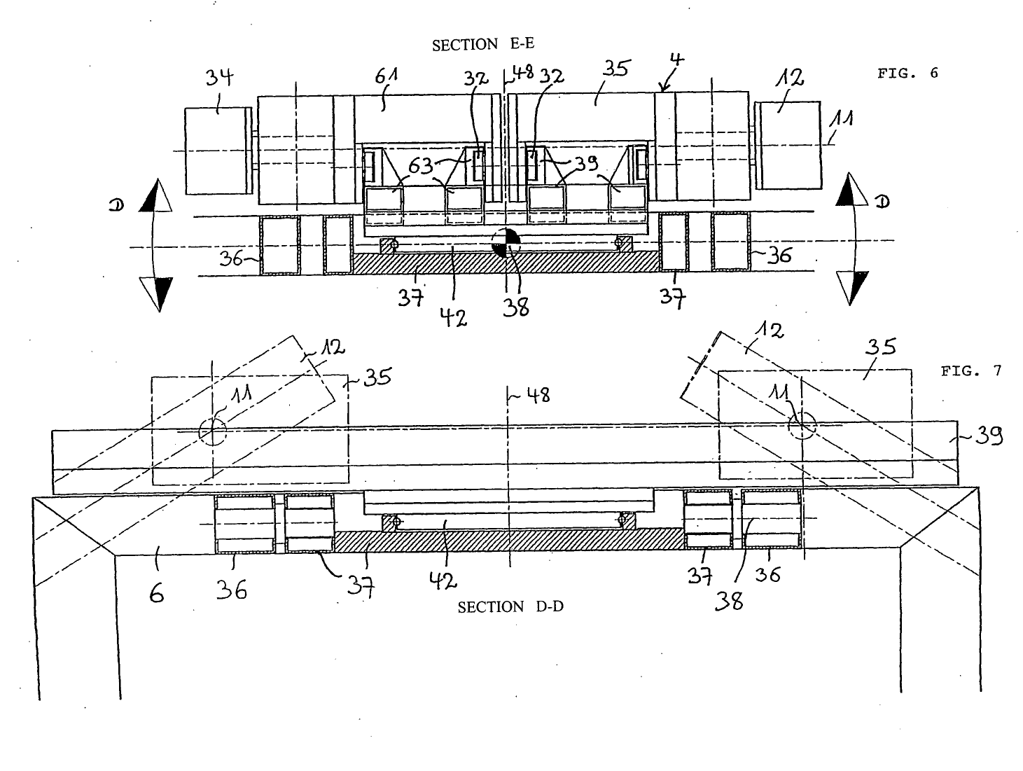

On the other hand, if vehicle 35 pivots around axis 38, which lies in plane B in this example and runs through the middle M of lengthwise axis 26, which is not absolutely necessary, then lengthwise axis 26 leaves plane B except at middle point M; the lengthwise axis 26 is thus inclined or tilted relative to plane B. Preferably, both adjustment possibilities are provided. A structural configuration can be seen in FIGS. 5, 6 and 7. Thus, tracks 39 for vehicle 35 (FIG. 5) are attached to an inner supporting element 37, which is attached to an outer supporting element 36 so that it can pivot around pivot axis 38. This can be seen in detail in sectional views E-E (FIG. 6) and D-D (FIG. 7). Arrows D thus represent the inclination of tracks 39 relative to the upper horizontal plane of the supporting structure, which leads to a corresponding inclination of the displacing device with arm 12, which projects out from plane B relative to the mentioned inclined movement of lengthwise axis 26. This movement of supporting element 37 around axis 38 can be carried out, e.g., by electric motors that are not shown. The above-mentioned pivoting of lengthwise axis 26 of the uptake for the roll of foil in plane B, on the other hand, is carried out by a rotation of tracks 39 around axis 48, which preferably is perpendicular to the horizontal plane of the supporting structure 6. For this purpose, tracks 39 are disposed on a rotating stage 42, which can rotate around axis 48 on supporting element 37, as can be seen from FIGS. 6 and 7. Tracks 63 for vehicle 61, which bears arm 30, are preferably adjustable in the same way as described for tracks 39, so that the welding device 32 automatically follows the adjustment of lengthwise axis 26 of the uptake for the roll of foil. For this movement, the two displacing devices are thus preferably coupled, while, as mentioned previously, they are independent relative to moving and pivoting.

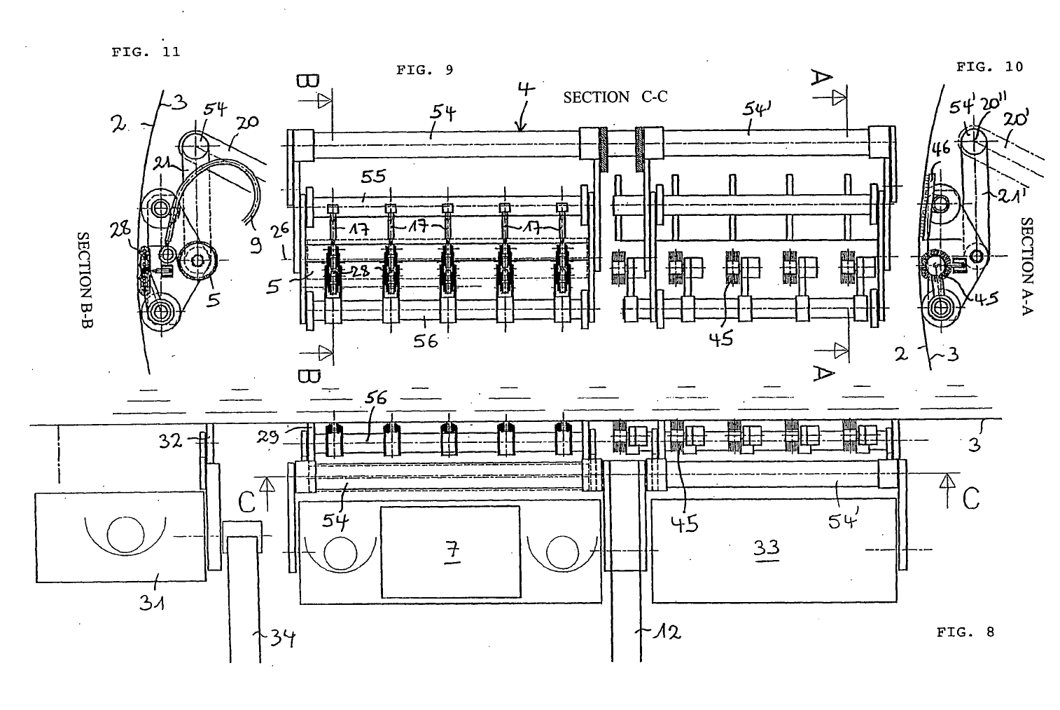

FIG. 8 shows in a view from the top an enlarged representation of the front end of the displacing device with work stagings 10, 33 and also 31. Not all elements of the foil sheeting guide are shown, but there can be seen the several sets of compression rolls 28 lying next to one another and also the corresponding rotating wire brushes, which pre-treat the wall 3 in the installation movement for a foil sheeting already installed, at those places where beads of hot-melt-type adhesive will come to lie in the installation of the next foil sheeting. Instead of or in addition to the wire brushes, milling cutting elements may also be provided, particularly in the case of very uneven tunnel walls. FIG. 9 shows a corresponding view of the tunnel wall with view onto the displacing device, wherein, again, the sets of compression rolls 28 can be seen as well as the application heads 17 for the liquid hot-melt-type adhesive, which are disposed correspondingly in this figure. Also visible in this figure is the uptake structure for the only indicated roll of foil 5, which is formed by shields 25 and 25′ with the joining rods 55 and 56, and this structure forms the lengthwise axis 26 for the uptake of the roll of foil. Also visible are the wire brushes 45, which are spaced at the same distances from one another as the sets of compression rolls or the application heads 10*, respectively. FIGS. 10 and 11 show corresponding sectional views corresponding to the section lines A-A and B-B of FIG. 9, in which the same elements are visible once more. In addition to the rotating round
sic; 17?—Trans. Note. wire brushes 45, linear wire brushes 46′ can be provided. The sites for applying the hot-melt-type adhesive can be dried by a drying device, if necessary, prior to introducing the adhesive.

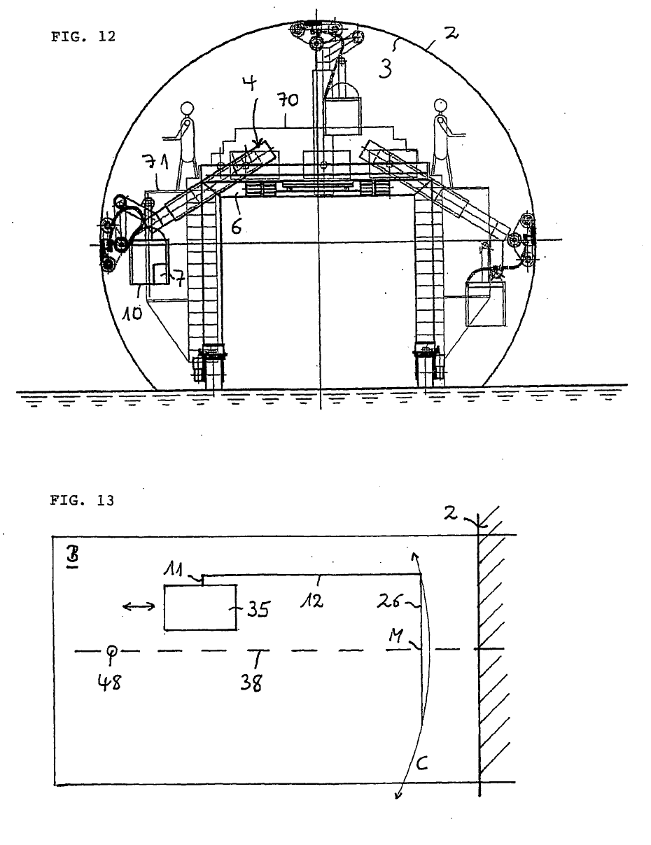

FIG. 12 shows another embodiment, in which the melting device is not guided along on a personnel-accessible platform, so that separate stages 70 and 71 are provided on the supporting structure 6.

FIG. 5 shows another preferred configuration of the wheels of the gantry crane 6, wherein these wheels 67 can be pivoted from a working position to a transport position 67′, whereupon the direction of rotation of the wheels is maintained. This permits a simpler transport of the device. In addition, the height of the gantry crane or the supporting structure, respectively, can be reduced for transport. FIG. 3 shows the configuration of the columns of the supporting structure 6 with the elements 66 and 68 that can be collapsed into one another. Further, for transport, the displacing devices are rotated by 90° in relation to the position visible in FIG. 5, so that the arms 12 and 34 come to lie in the lengthwise direction of the supporting structure. In this way, a simple transport of the entire device can be conducted.

While preferred embodiments of the invention are described in the present Application, it is clearly indicated that the invention is not limited to these and can be embodied also in other ways within the scope of the following claims.

1. A method for attaching foil sheetings (15) to surfaces of structures, in particular to tunnel walls, in which at least one supply of foil sheeting, in particular a roll of foil (5), moves along the surface (3) to be covered by means of an installation movement and thus the foil sheeting (15) is pulled from the supply or off the roll and is applied to the surface, wherein the foil sheeting (15) is attached to the surface (3) by a hot-melt-type adhesive prepared by a melting device (7, 8), is hereby characterized in that the melting device (7, 8) is guided together with the supply of foil or the roll of foil in the installation movement.

2. The method according to claim 1, further characterized in that the melting device (7, 8) prepares foamed hot-melt-type adhesive, whereby, in particular, the gas supply (8) for the foaming is also guided along in the installation movement.

3. The method according to claim 1, further characterized in that the melting device (7, 8) is disposed on a platform (10) remaining essentially horizontal during the installation movement.

4. The method according to claim 3, further characterized in that the platform (10) is configured as a work staging accessible to personnel.

5. The method according to claims claim 1, further characterized in that the hot-melt-type adhesive is introduced on to the foil sheeting by individual application heads (17) fed separately from the melting device.

6. A method for attaching foil sheetings (15) to surfaces of structures, in particular to tunnel walls, in which at least one supply of foil sheeting, in particular a roll of foil (5), moves along the surface (3) to be covered by means of an installation movement and thus the foil sheeting (15) is pulled from the supply or off the roll and is applied to the surface, wherein the foil sheeting (15) is attached to the surface (3) by attachment means, in particular by a hot-melt-type adhesive prepared by a melting device (7, 8), in particular according to one of claims 1 to 5, is hereby characterized in that the installation movement is produced by means of a displacing device (4), which bears the supply of foil, in particular the roll of foil, on one end, and which at the other end, can be moved, especially can be moved horizontally, for executing the installation movement, and is also disposed so that it can pivot on a supporting structure (6), in particular, a gantry crane.

7. The method according to claim 6, further characterized in that the displacing device is adjustable in length and in particular has a length-adjustable arm (12) and, in particular, has a telescopic length-adjustable arm, wherein the pivot axis (11) of the arm can be arranged so that it can move on the supporting structure.

8. The method according to claim 6, further characterized in that the lengthwise axis (26) of the roll of foil (5) in the horizontal plane determined by this lengthwise axis can be pivoted out from a position in which the lengthwise axis (26) is parallel to the line of intersection of the horizontal plane with the surface of the structure, driven into positions in which the lengthwise axis is not parallel to this line of intersection.

9. The method according to claim 6, further characterized in that the lengthwise axis (26) of the roll of foil (5) can be pivoted back and forth, driven out from the horizontal plane determined by this lengthwise axis, in particular, so that the lengthwise axis maintains one point in the plane.

10. The method according to claim 8, further characterized in that the pivoting movement of the lengthwise axis (26) of the roll of foil (5) is executed by a corresponding movement of the displacing device (4) on supporting structure (6).

11. The method according to claim 7, further characterized in that the pivoting movement of the lengthwise axis (26) of the roll of foil (5) is executed by making the pivot axis (11) of the arm (12) rotatable around an axis of rotation (48) that is perpendicular to the horizontal plane B.

12. The method according to claim 7, further characterized in that the pivoting movement of the lengthwise axis (26) of the roll of foil (5) out from the horizontal plane B is executed by tilting the pivot axis (11) of the arm (12) around a horizontal tilting axis (38).

13. A device (1) for attaching foil sheetings (15) to surfaces of structures (3), in particular to tunnel walls, comprising a supporting structure (6), a displacing device disposed thereon, configured for the uptake of at least one supply of foil sheeting, in particular, a roll of foil (5), which is configured for executing an installation movement, in which a foil sheeting can be pulled from the supply or off the roll (5) and can be applied to the surface of the structure, as well as a melting device (7, 8) for preparing a molten adhesive from a solid hot-melt-type adhesive material, is hereby characterized in that the melting device (7, 8) is joined with the displacing device (4) or a part of the same, so that it takes part in the installation movement.

14. A device (1) for attaching foil sheetings (15) to surfaces of structures (3), in particular to tunnel walls, comprising a supporting structure (6), a displacing device disposed thereon, configured for the uptake of at least one supply of foil sheeting, in particular, a roll of foil (5), which is configured for executing an installation movement, in which a foil sheeting can be pulled from the supply or off the roll (5) and can be applied to the surface of the structure, in particular, according to claim 13, is hereby characterized in that the displacing device (4) is disposed so that it can move, in particular that it can move horizontally in parallel and also can pivot on supporting structure (6), for executing the installation movement.

15. The device according to claim 13, further characterized by a platform (10) that is joined with the displacing device, on which the melting device is disposed.

16. The device according to claim 15, further characterized in that the platform (10) is disposed so that it remains essentially horizontal during the installation movement.

17. The device according to claim 16, further characterized in that the platform is configured as a work staging.

18. The device according to claim 13, further characterized in that the displacing device (4) has at least one arm (12), which can be pivoted around an axis (11) on supporting structure (6), which runs essentially parallel to the lengthwise axis (26) of the uptake for the roll of foil.

19. The device according to claim 18, further characterized in that the axis (11) is disposed on supporting structure (6) so that it can be adjusted in its inclination relative to the horizontal plane.

20. The device according to one of claim 18, further characterized in that the axis (11) can be rotated around another axis (48) that is essentially perpendicular to the horizontal plane.

21. The device according to claim 11, further characterized in that it is a length-adjustable arm and, in particular, a telescopic arm.

22. The device according to claim 13, further characterized in that the arm has a device for pretreating the tunnel walls (3) that can be moved together with the supply of foil sheeting, this device being disposed in front of the supply of foil sheeting in the direction of travel of the movable supporting structure (6) and, in particular, has wire brushes (45, 46) and/or milling cutters, which are particularly disposed at the same distance from as are the application heads disposed on the melting device.

23. The device according to claim 22, further characterized in that the pretreatment device can also be moved by the displacing device (4).

24. The device according to claim 13, further characterized in that the device comprises a welding device (49), which can be moved, in particular, by means of another, preferably horizontal, movable and also pivotable displacing device, in particular, an arm (34, 61).

25. The device according to claim 24, further characterized in that the movement of the other displacing device (34, 61) is independent from the installation movement of the first displacing device (12, 35), apart from the pivoting movement of the lengthwise axis (26) for the uptake of the roll of foil in the horizontal plane by this and the inclining movement of the lengthwise axis (26), which are also conducted by the second displacing device (34, 61).

26. Use of foamed hot-melt-type adhesive for attaching foil sheetings to tunnel arches, in particular to pneumatically-applied concrete arches.

27. The use according to claim 26, further characterized in that the adhesive surfaces for the hot-melt-type adhesive are pretreated by wire brushes and/or milling cutters.
